(19) United States
(12) Patent Application Publication
(10) Pub. No.: US 2019/0010017 A1
(43) Pub. Date: Jan. 10, 2019

(54) LANDING FLOOR DOOR INDICATOR PANEL

(71) Applicants: Laurent COLDRE, Gien (FR); Otis Elevator Company, Farmington, CT (US)

(72) Inventor: Laurent Coldre, La neuville sur essonne (FR)

(21) Appl. No.: 16/066,838

(22) PCT Filed: Dec. 28, 2015
(86) PCT No.: PCT/IB2015/002567

§ 371 Date: Jun. 28, 2018

(51) Int. Cl. B66B 3/00; B66B 13/30; B66B 9/00; B23K 26/362

(52) U.S. Cl. CPC B66B 3/002; B23K 26/362; B66B 9/00; B66B 13/303

(57) ABSTRACT

A landing floor door (36) for an elevator system (10) includes a door body (48) and a door pocket (50) located at the door body (48). A display panel (56) is located at the door pocket (50) and includes a panel having a front surface (72) and a back surface (70), the back surface (70) offset from the front surface (72) by a panel thickness (66). One or more transparent portions are formed in the panel, and at least one light source (60) associated with each transparent portion of the one or more transparent portions is located at a panel edge (62) of the panel. The at least one light source (60) is configured and oriented to emit a light into the panel in a direction transverse to the panel thickness (66). When the at least one light source (60) is activated, light is transmitted through the associate transparent portion, thus displaying a selected image or light pattern (76).

### BACKGROUND

The subject matter disclosed herein relates to elevator systems. More particularly, the present disclosure relates to elevator status indicator displays.

Elevator systems typically include landing doors at each landing floor of the elevator system. Elevator call buttons are located on a wall next to the elevator landing doors for a user to call the elevator to the particular landing floor. The elevator system may further include indicators or screens located at the wall to give the user indication of direction of travel of the elevator car, floor at which the elevator car is currently located or other information.

The screens and indicators are costly devices that are difficult to integrate into a homogeneous design that is pleasing to the user.

### BRIEF SUMMARY

In one embodiment, a landing floor door for an elevator system includes a door body and a door pocket located at the door body. A display panel is located at the door pocket and includes a panel having a front surface and a back surface, the back surface offset from the front surface by a panel thickness. One or more transparent portions are formed in the panel, and at least one light source associated with each transparent portion of the one or more transparent portions is located at a panel edge of the panel. The at least one light source is configured and oriented to emit a light into the panel in a direction transverse to the panel thickness. When the at least one light source is activated, light is transmitted through the associate transparent portion, thus displaying a selected image or light pattern.

Additionally or alternatively, in this or other embodiments one or more of the front surface or the back surface of the panel is etched to facilitate display of the selected image or light pattern.

Additionally or alternatively, in this or other embodiments etching of the front surface and/or the back surface modifies light incidence and simulates a light source emitting light parallel to the panel thickness.

Additionally or alternatively, in this or other embodiments the etching is accomplished via a laser etching process.

Additionally or alternatively, in this or other embodiments a protective cover is positioned over the front surface.

Additionally or alternatively, in this or other embodiments the light source is one or more light emitting diodes.

Additionally or alternatively, in this or other embodiments the selected image or light pattern is indicative of one or more of direction of travel of an elevator car in a hoistway, a floor at which the elevator car is currently located, number of passengers in the elevator car, current wait time for arrival of the elevator car at a landing floor, or a service indicator of the elevator system.

Additionally or alternatively, in this or other embodiments the door pocket extends inwardly from a door panel edge to facilitate insertion and/or removal of the display panel therefrom.

In another embodiment, an elevator system includes a hoistway, an elevator car drivable along the hoistway, and one or more landing floors positioned along the hoistway. Each landing floor includes a landing floor door to allow passenger entry to and exit from the elevator car at the landing floor. The landing floor door includes a door body, a door pocket located at the door body, and a display panel positioned at the door pocket. The display panel includes a panel having a front surface and a back surface, the back surface offset from the front surface by a panel thickness. One or more transparent portions are formed in the panel. At least one light source is associated with each transparent portion of the one or more transparent portions located at a panel edge of the panel and is configured and oriented to emit a light into the panel in a direction transverse to the panel thickness. When the at least one light source is activated, light is transmitted through the associate transparent portion, thus displaying a selected image or light pattern.

Additionally or alternatively, in this or other embodiments one or more of the front surface or the back surface of the panel is etched to facilitate display of the selected image or light pattern.

Additionally or alternatively, in this or other embodiments etching of the front surface and/or the back surface modifies light incidence and simulates a light source emitting light parallel to the panel thickness.

Additionally or alternatively, in this or other embodiments the etching is accomplished via a laser etching process.

Additionally or alternatively, in this or other embodiments a protective cover is positioned over the front surface.

Additionally or alternatively, in this or other embodiments the light source is one or more light emitting diodes.

Additionally or alternatively, in this or other embodiments the selected image or light pattern is indicative of one or more of direction of travel of an elevator car in a hoistway, a floor at which the elevator car is currently located, number of passengers in the elevator car, current wait time for arrival of the elevator car at a landing floor, or a service indicator of the elevator system.

Additionally or alternatively, in this or other embodiments the door pocket extends inwardly from a door panel edge to facilitate insertion and/or removal of the display panel therefrom.

These and other features of exemplary embodiments are disclosed herein.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of an embodiment of an elevator system;

FIG. 2 is a schematic view of an embodiment of a landing floor door arrangement for an elevator system;

FIG. 3 is a cross-sectional view of a display panel for a landing floor door; and

FIG. 4 is a partial perspective view of an embodiment of a landing floor door for an elevator system.

### DETAILED DESCRIPTION

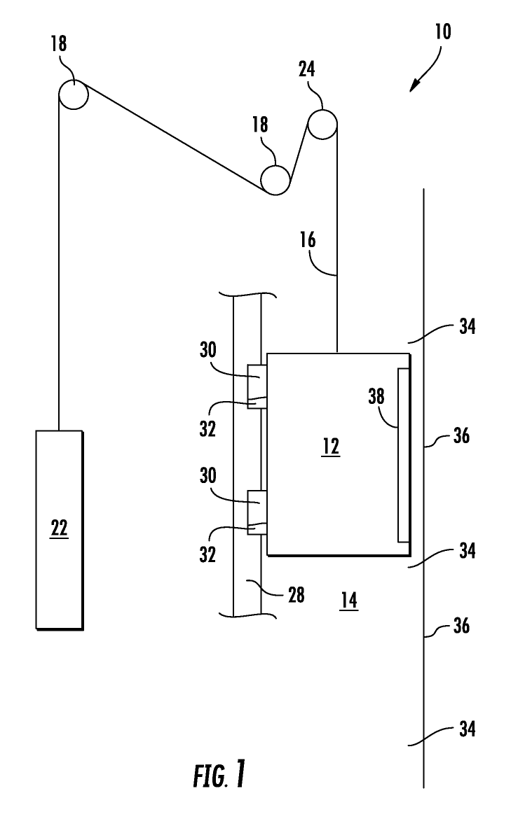

Shown in FIG. 1 is a schematic of an exemplary elevator system 10. The elevator system 10 includes an elevator car 12 operatively suspended or supported in a hoistway 14 with one or more suspension members 16, such as ropes or belts. The one or more suspension members 16 interact with one or more sheaves 18 to be routed around various components of the elevator system 10. The one or more sheaves 18 could also be connected to a counterweight 22, which is used to help balance the elevator system 10 and reduce the difference in suspension member 16 tension on both sides of a traction sheave 24 during operation.

The hoistway 14 includes one or more landing floors 34 at which the elevator car 12 stops to allow ingress and/or egress of passengers from the elevator car 12 through elevator car door 38. A landing floor door 36 is located at each landing floor 34 of the hoistway 14. During elevator system operation, the landing floor door 36 opens when the elevator car 12 is present at the landing floor 34 to allow for passenger ingress and/or egress. In some embodiments, this is enabled by a mechanical interlock between the elevator car door 38 and the landing floor door 36 when the elevator car 12 is present at the landing floor 34. It is to be appreciated that while double elevator car doors 38 and landing floor doors 36 are shown in the FIGs. and described herein, the present disclosure may be readily applied to elevator cars 12 with single elevator car doors 38 and landing floors 34 with single landing floor doors 36 at each hoistway 14.

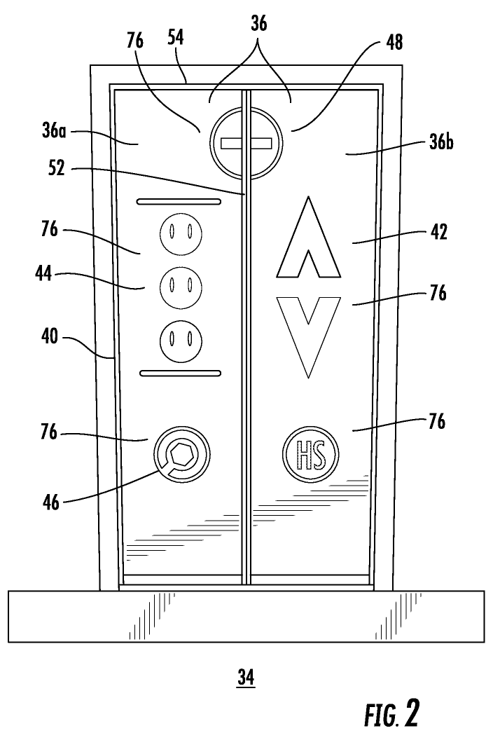

Shown in FIG. 2 is an embodiment of a set of landing floor doors 36 located at an exemplary landing floor 34 of the elevator system 10. The set of landing floor doors 36 includes first landing floor door 36a and second landing floor door 36b, which open and close be moving away from each other and toward each other at landing opening 40. The landing floor doors 36a, 36b are configured to dynamically display information useful to elevator system users at the landing floor 34. The displayed information may be one or more light patterns 76 indicating, for example, direction of travel of the elevator car 12 in the hoistway 14 shown at 42, floor at which the elevator car 12 is currently located, number of passengers in the elevator car 12 shown at 44, current wait time for arrival of the elevator car 12 at the landing floor 34, or the like. Further, the landing floor door 36 may display a service indicator 46 when the elevator system 10, or a particular elevator hoistway 14 is out of service for maintenance or repair. In some embodiments, the displayed information may include a door closed indicator 48 to indicate when the landing floor door 36 is opened or closed, or may further indicate arrival of the elevator car 12 at the landing floor 34.

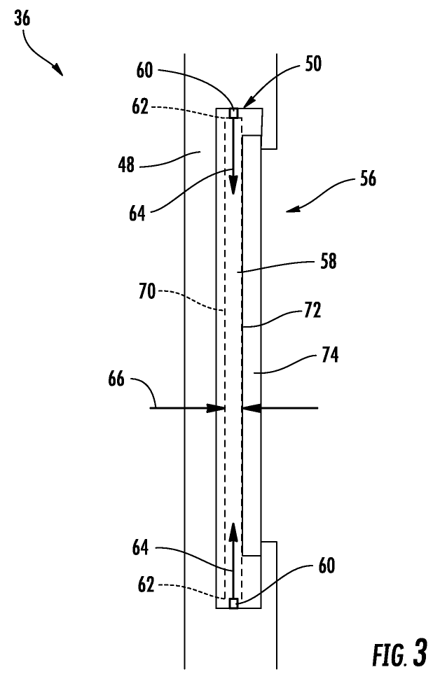

Referring now to FIG. 3, a cross-sectional view of an embodiment of a landing floor door 36 is shown. The landing floor door 36 includes a door body 48, in some embodiments formed from steel or another metal material. The door body 48 includes a door pocket 50, in some embodiments extending inwardly from a door lateral edge 52 (see FIG. 2) of the door body 48 while in other embodiments extending from other portions of the door body 48 such as, for example, extending downwardly from a door top edge 54 (see FIG. 2). The door pocket 50 is receptive of a display panel 56, which is configured to display the light pattern 76 viewable by elevator system 10 users at the landing floor 34. The display panel 56 includes an etched transparent panel 58 operably connected to one or more light sources 60. Each light source 60 is, for example, a light-emitting diode disposed at a transparent panel edge 62 such that light 64 from the light source is directed perpendicular to a panel thickness 66 of the transparent panel 58 through the transparent panel 58 between a back surface 70 and a front surface 72 facing the landing floor 34. The transparent panel 58 is, in some embodiments, formed from a polycarbonate material. The transparent panel 58 is etched leaving one or more transparent patterns 76 of a selected shape, such as an arrow or a numeral or combination of symbols or alphanumeric characters. Each transparent pattern 76 has a light source 60 associated with it, such that when a selected light source 60 is activated, light is transmitted through the associated transparent pattern 76, such that a desired light pattern or image is produced and displayed at the transparent panel 58.

The etching of the transparent panel 58 modifies light incidence and simulates a perpendicular light source, such that light transmission through the transparent panel 58 is blocked at etched portions on the transparent panel 58, and light is transmittable through the transparent patterns 76 of the transparent panel 58. The etching may be performed on the front surface 72 by any suitable process, for example, by a laser etching process such that the desired image or images are displayed at the transparent panel 58 when light 64 from the light source 60 is projected through the transparent panel 58. The light source 60 may be configured to transmit any one or a number of light colors, as desired to display the desired image or light pattern via the transparent pattern 76.

In some embodiments, the display panel 56 may include a protective glass panel 74 placed over the front surface 72 of the transparent panel 58 to protect the transparent panel 58 from damage or marring which may lead to distortion of the displayed image or light pattern and/or failure of the display panel 56.

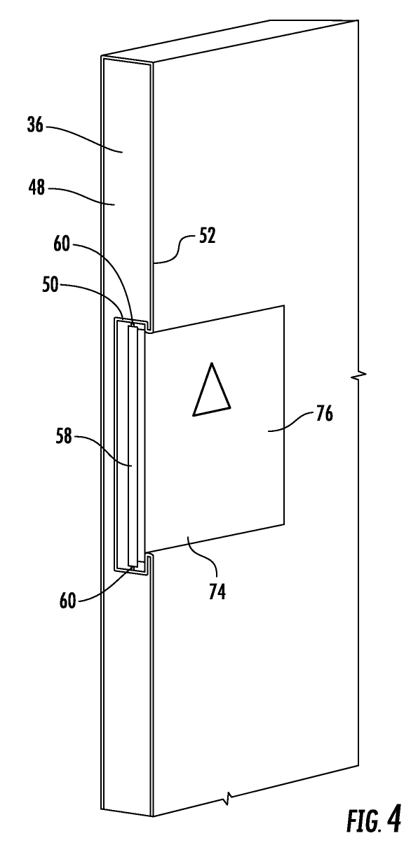

Referring now to FIG. 4, while the door pocket 50 receptive of the transparent panel 58 may be located anywhere on the door body 48, it is advantageous to locate the door pocket 50 at an edge of the door body 48 to enable easy removal and replacement of the transparent panel 58 and/or the light source 60 by sliding the components from the door pocket 60. Removal of the components may be desired for, for example, repair of the components or to exchange the transparent panel 58 for another transparent panel 58 to change the image or light pattern 76 to be displayed at the display panel 56.

As stated above, the transparent pattern 76 in the transparent panel 58 and the associated light pattern or image displayed may be indicative of, for example, direction of travel of the elevator car 12 in the hoistway 14 shown at 42, floor at which the elevator car 12 is currently located, number of passengers in the elevator car 12 shown at 44, current wait time for arrival of the elevator car 12 at the landing floor 34, or the like. Further, the landing floor door 36 may display a service indicator 46 when the elevator system 10, or a particular elevator hoistway 14 is out of service for maintenance or repair. In some embodiments, the displayed information may include a door closed indicator 48 to indicate when the landing floor door 36 is opened or closed, or may further indicate arrival of the elevator car 12 at the landing floor 34.

The system described herein is simple and efficient, allowing for a multiude of images or other information to be displayed at the landing floor doors 36 for the benefit of elevator system 10 users at the landing floor 34. Further, since the light source 60 is located at a transparent panel edge 62, no wiring or other components are visible behind the displayed light pattern or image, giving a clean appearance.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A landing floor door for an elevator system, comprising:
a door body;
a door pocket disposed at the door body; and
a display panel disposed at the door pocket, the display panel including:
a panel having a front surface and a back surface, the back surface offset from the front surface by a panel thickness;
one or more transparent portions formed in the panel; and
at least one light source associated with each transparent portion of the one or more transparent portions located at a panel edge of the panel and configured and oriented to emit a light into the panel in a direction transverse to the panel thickness;
wherein when the at least one light source is activated, light is transmitted through the associate transparent portion, thus displaying a selected image or light pattern.

2. The landing floor door of claim 1, wherein one or more of the front surface or the back surface of the panel is etched to facilitate display of the selected image or light pattern.

3. The landing floor door of claim 2, wherein etching of the front surface and/or the back surface modifies light incidence and simulates a light source emitting light parallel to the panel thickness.

4. The landing floor door of claim 2, wherein the etching is accomplished via a laser etching process.

5. The landing floor door of claim 1, further comprising a protective cover disposed over the front surface.

6. The landing floor door of claim 1, wherein the light source is one or more light emitting diodes.

7. The landing floor door of claim 1, wherein the selected image or light pattern is indicative of one or more of direction of travel of an elevator car in a hoistway, a floor at which the elevator car is currently located, number of passengers in the elevator car, current wait time for arrival of the elevator car at a landing floor, or a service indicator of the elevator system.

8. The landing floor door of claim 1, wherein the door pocket extends inwardly from a door panel edge to facilitate insertion and/or removal of the display panel therefrom.

9. An elevator system, comprising:
a hoistway;
an elevator car drivable along the hoistway; and
one or more landing floors disposed along the hoistway, each landing floor including a landing floor door to allow passenger entry to and exit from the elevator car at the landing floor, the landing floor door including:
a door body;
a door pocket disposed at the door body; and
a display panel disposed at the door pocket, the display panel including:
a panel having a front surface and a back surface, the back surface offset from the front surface by a panel thickness;
one or more transparent portions formed in the panel; and
at least one light source associated with each transparent portion of the one or more transparent portions located at a panel edge of the panel and configured and oriented to emit a light into the panel in a direction transverse to the panel thickness;
wherein when the at least one light source is activated, light is transmitted through the associated transparent portion, thus displaying a selected image or light pattern.

10. The elevator system of claim 9, wherein one or more of the front surface or the back surface of the panel is etched to facilitate display of the selected image or light pattern.

11. The elevator system of claim 10, wherein etching of the front surface and/or the back surface modifies light incidence and simulates a light source emitting light parallel to the panel thickness.

12. The elevator system of claim 11, wherein the etching is accomplished via a laser etching process.

13. The elevator system of claim 9, further comprising a protective cover disposed over the front surface.

14. The elevator system of claim 9, wherein the light source is one or more light emitting diodes.

15. The elevator system of claim 9, wherein the selected image or light pattern is indicative of one or more of direction of travel of an elevator car in a hoistway, a floor at which the elevator car is currently located, number of passengers in the elevator car, current wait time for arrival of the elevator car at a landing floor, or a service indicator of the elevator system.

16. The elevator system of claim 9, wherein the door pocket extends inwardly from a door panel edge to facilitate insertion and/or removal of the display panel therefrom.
